(19) United States
(12) Patent Application Publication
(10) Pub. No.: US 2005/0032227 A1
(43) Pub. Date: Feb. 10, 2005

(54) Analytical technique

(76) Inventor: Philip Stephen Goodall, Cumbria (GB)

Correspondence Address: MYERS BIGEL SIBLEY & SAJOVEC, PO BOX 37428, RALEIGH, NC, 27627, US

(21) Appl. No.: 10/484,514

(22) PCT Filed: Jul. 15, 2002
(86) PCT No.: PCT/GB02/03214

(30) Foreign Application Priority Data
Jul. 17, 2001 (GB) 0117352.5

(51) Int. Cl. G01N 23/00

(52) U.S. Cl. 436/57

(57) ABSTRACT

Radionuclides are determined by adding a combined carrier and a tracer to a sample to be analysed. The sample is mineralized by pyrolysizing and/or pyrohydrolysizing the sample. The resulting analyte is isolated and the analyte is analyzed.

This invention relates to a novel analytical technique.

In particular the present invention relates to a technique for the analysis of materials, that include, but are not limited to, highly radioactive substances of interest in the nuclear fuel cycle. This analytical process has the purpose of determining radionuclides including, but not limited to, C-14, I-129, C1-36, Tc-99, Ru-106 and S-35.

The primary feature of the present invention is the removal of any uncertainty from the determination generated by the chemical or physical form of the analytes of interest, i.e., the true total specific radionuclide content is determined.

With particular reference to iodine-129 and carbon-14:

Iodine-129

A semi-routine analytical method exists for the determination of total I-129 in spent fuel solutions. There is some ambiguity in the measurement and it is believed that only soluble, inorganic forms of I-129 are detected and quantified by this method of analysis. The procedure involves a two-stage preparation, in a heavily shielded facility, using precipitation and ion exchange to remove extraneous radionuclides. This crude fraction may then be exported to a comparatively low level protection environment, such as a fume-hood or a radio-bench, for further purification before determination of the I-129 content by low energy photon spectroscopy (LEPS).

In addition, a variety of standard literature methods have been used to determine total and speciated forms of iodine in radioactive materials. These procedures do not yield information as to the isotopic form of the analyte of interest. For example:
Total iodine after reduction to I³¹ with ascorbic acid followed by ion selective electrode (ISE) potentiometry.
Iodine speciation by the determination of iodide by DC polarography, iodate by differential pulse polarography and solvated iodine by spectrophotometry. The total chemical iodine was determined, after reduction to iodide, by ISE or polarography.
   Carbon-14

There are no methods available currently available for the determination of C-14 in highly radioactive samples. A method for the determination of C-14 in intermediate level waste forms (Ba(CO₃) slurries) has been developed. This method determines C-14 present as carbonate but would not necessarily detect C-14 present in other chemical forms. In outline, the Ba(CO₃) slurry is treated with dilute mineral acid, the evolved CO₂ washed and absorbed in aqueous sodium hydroxide with subsequent radiometric counting of the solution.

In general, the precision obtained using classical radiometric techniques for the determination of residual radionuclides of interest in highly active materials preclude a precise determination. Thus, we have found that it may be highly desirable to utilise the advantages of advanced mass spectrometry.

U.S. Pat. No. 5,438,194—Koudijs et al. describes a method of detecting radioisotope molecules which comprises the steps of:
(i) separating molecules by use of a chromatographic column;
(ii) coupling the column output to an ion source system which produces negative ions;
(iii) directing the negative ions into a tandem accelerator mass spectrometer to form high velocity positive ions; and
(iv) stopping the positive ions in a particle detector.

This is not a viable option with highly active materials as it is not practical to couple these materials to an extremely expensive mass spectrometer via a chromatographic interface. This system provides information that differs fundamentally from that provided by our approach, i.e., the radionuclide content of specific volatile or semi-volatile chemical compounds within a given sample is determined. In contrast, our system determines the total radionuclide of interest in a material irrespective of the chemical or physical form of that radionuclide.

We have now found an improved method for the determination of radionuclides, which overcomes or mitigates the disadvantages of prior art approaches.

U.S. Pat. No. 3,830,628 discloses a method and apparatus for the processing of fluid materials, particularly for the preparation of samples for radioactive tracer studies by combustion of starting materials containing such isotope tracers. However, the patent does not mention the subsequent analysis of the derived analytes and, furthermore, the disclosed technique relies on the oxidation of necessarily organic substrates and, consequently, provides no significant separation of the components. The method of the present invention, however, utilises pyrolysis and pyrohydrolysis of the starting materials, thereby reducing the materials in order promote volatilisation, with resulting separation of the components from a largely inorganic, and hence incombustible, substrate.

U.S. Pat. No. 3,811,838 teaches a method and apparatus for the processing of fluid materials, particularly for the preparation of samples for radioactive isotope tracer studies by combustion of starting materials containing such isotope tracers. Again, however, the method relies on simple combustion techniques in a combustion chamber, rather than the pyrolysis and pyrohydrolysis techniques of the method of the present invention and, in addition, the patent fails to mention the use of a carrier, which facilitates the analysis of minute amounts of radioactive material according to the method of the present invention.

Thus according to the invention we provide a method for the determination of specified radionuclides which comprises the steps of:
(i) addition of a combined carrier and tracer to a sample to be analysed;
(ii) mineralisation of the sample;
(iii) isolation of the resulting analyte; and
(iv) analysis of the analyte,
   characterised in that the step of mineralisation of the combined carrier and tracer sample comprises pyrolysis and/or pyrohydrolysis.

Preferentially, the step of pyrolysis and/or pyrohydrolysis will be followed by subsequent absorption and/or adsorption of evolved gasses and vapours into or onto a substrate.

The method of the invention extends and validates a sample preparation methodology, based upon pyrohydrolysis, for the determination of radionuclides of interest. This analysis may be, but is not necessarily limited to, highly radioactive materials.

The pyrohydrolysis has the following features:
Converts all chemical and physical forms of the analytes of interest into soluble, inorganic forms.
Provides an efficient matrix removal.
Has been proven to work as a routine method under restrictive engineering controls.

The step of isolating the desired analyte from the substrate may also include a further step of purification of the analyte. The isolation and/or purification step may subsequently include the step of preparing a source for measurement of the analyte of interest. Such analysis may itself comprise:
(i) determination of analytes of interest by classical radiometric techniques, or
(ii) determination of analytes of interest by inorganic mass spectrometry, e.g., accelerator mass spectrometry and/or inductively coupled plasma mass spectrometry.

The invention will now be described, by way of embodiments, with reference to the accompanying drawings in which:

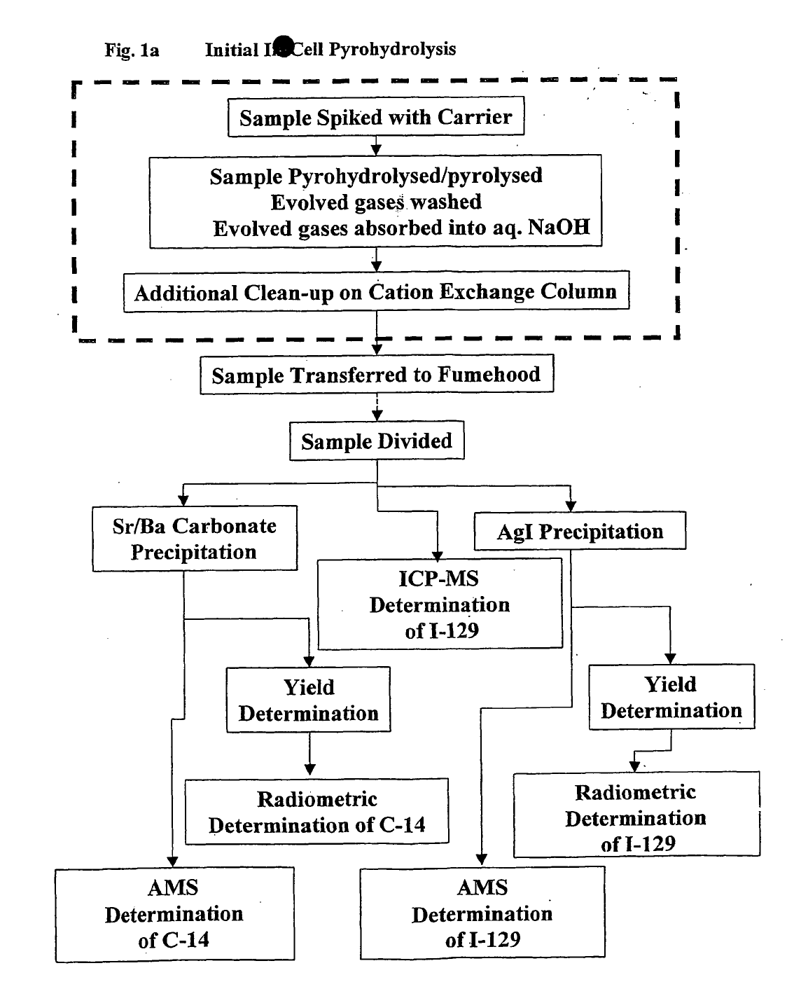

FIG. 1a is a schematic representation of a flow sheet for an initial pyrohydrolysis performed in a heavily shielded remote facility.

FIG. 1b is a schematic representation of a flow sheet for a large scale dilution, calibrated by isotope dilution techniques, performed in a heavily shielded remote facility;

FIG. 1c is a schematic representation of a flow sheet for a hybrid approach.

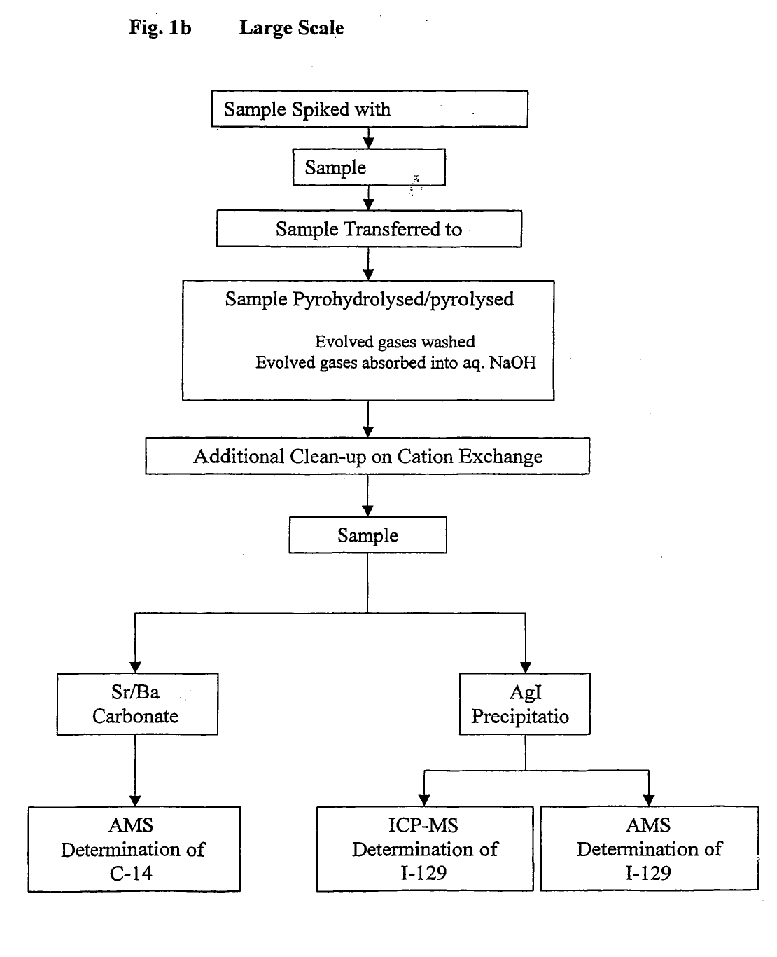

FIGS. 2 to 4 are schematic representations of apparatus suitable for carrying out the method of the invention; and

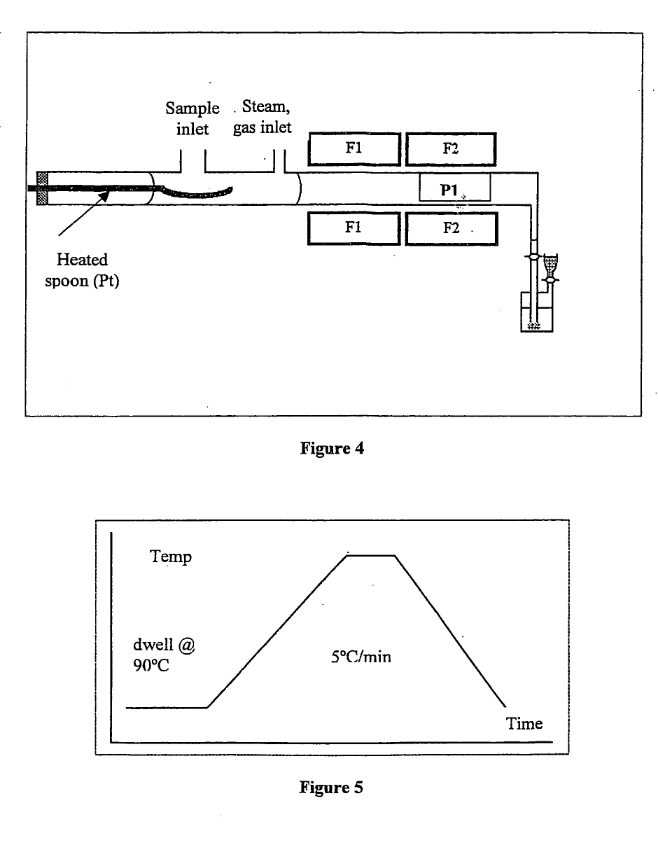

FIG. 5 is a temperature profile for the operation of pyrohydrolysis apparatus inside a hot cell.

An analytical process based upon pyrohydrolysis offers the possibility of determining both C-14 and I-129 on a single sample aliquot. Three approaches are proposed for the determination of I-129 and C-14.
a) A remote pyrohydrolysis in a highly shielded facility and, if required, additional sample purification in that facility prior to export of the processed sample to a comparatively low level protection environment for subsequent processing (FIG. 1a).
b) A large dilution of the sample, calibrated using isotope dilution methodologies, in a highly shielded facility prior to export to a comparatively low level protection environment for pyrohydrolysis and subsequent processing (FIG. 1b).
c) A hybrid approach including, a pyrohydrolysis and calibrated dilution in a highly shielded facility, with export to a comparatively low level protection environment for with subsequent sample preparation (FIG. 1c).

A radio-bench offers a suitable comparatively low level protection environment in each case.

The large dilution approach is attractive in terms of minimising remote manipulations in the highly shielded facility. This assumes that solids are present either as a colloid or stable suspension and can be sampled and diluted representatively. The hybrid methodology minimises any potential errors due to sampling of very dilute suspensions by homogenising the sample prior to dilution whilst minimising subsequent manipulations.

The process is further advantageous and has the following features:
The sample preparation is robust, aggressive, efficient and therefore tolerant of a wide range of sample matrixes.
   The sample preparation effects a complete separation of the analytes of interest from the matrix and consequently reduces the interference of matrix species on the final determination.
The sample preparation and subsequent production of a source can be tailored to either a classical radiometric or mass spectrometric determination of the analytes of interest.

Other potentially volatile radionuclides may be amenable to determination via this approach, e.g., S-35, Cl-36, Tc-99 and Ru-106.

These features suggest that:

This basic methodology could evolve into a general approach for the determination of C-14 and I-129 in a wide variety of sample types, e.g.,
Process streams of concern in the nuclear fuel cycle ranging in activity between highly active and essentially non-radioactive, e.g., spent fuel solutions. These process streams may be solids, liquids or gases.
Process waste streams of concern in the nuclear fuel cycle ranging in activity between highly active and essentially non-radioactive, e.g.:
These process streams may be solids, liquids or gases.
Process waste forms of concern in the nuclear fuel cycle ranging in activity between highly active and essentially non-radioactive. These process waste forms are normally solids, e.g., vitrified high level wastes and cementated intermediate level waste.
Materials originating from the environment and/or which are of environmental concern, e.g. as part of an environmental study or survey
   fish
   milk
   grass
   etc.

The basic aims of this methodology could be extended to the determination of other volatile radionuclides in a similar broad spectrum of sample matrices.

### EXAMPLES

Detailed embodiments of the invention will now be described by way of examples only.

The presence of ¹²⁹I poses a significant challenge in the reprocessing of nuclear fuel. Unlike ¹³¹I, ¹²⁹I has a very long half-life of 1.57×10⁷ y, undergoing β-decay to the meta-stable isotope ^{129m}Xe. Due to the volatile nature of iodine and many of its compounds, secure and indefinite containment is difficult. Although ¹²⁹I has a low specific activity of 6.531×10⁶ Bqg⁻¹, its radiotoxicity is magnified as it is taken readily into the food chain and the human body accumulates iodine in the thyroid gland. Similarly, ¹⁴C is also a problem due to its volatility as ¹⁴CO₂ which may easily be released from barium carbonate slurries.

Previous studies have shown that the amount of iodine remaining after sparging in the dissolver liquors of the THORP reprocessing method is <2% of the original inventory. However, there is some ambiguity as to whether the total or soluble ¹²⁹I is measured. This ambiguity could be resolved by a sample treatment aimed at producing soluble iodine species.

Pyrohydrolysis Pyrohydrolysis involves heating (typically 500-1000° C.) solid/liquid samples in a stream of moist air/oxygen/nitrogen and absorption of the evolved gases into a trapping solution. As the iodine containing species (I₂, I⁻) are trapped simultaneously in aqueous solution this method offers a more accurate value of the total iodine content of the high activity (HA) liquors.
An Example of a Typical Reaction is

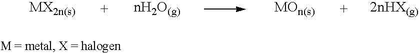

The gas stream of N₂, O₂, air etc is applied to wash the evolved HX into the trap solution. Once the volatile halogen containing species are trapped in solution, the total halogen content can be determined by a number of methods including ion-selective electrodes (ISE), ion chromatography (IC), spectrophotometry, XRF spectrometry, radiochemical neutron activation analysis (RNAA) and more recently inductively coupled plasma mass spectrometry (ICP-MS). A typical procedure involves pyrohydrolys is of 10-100 mg of the iodine containing species and trapping the evolved gases in 50 ml of 1M NaOH solution. The solution is then neutralised by the addition of 1M HCl and ascorbic acid added to reduce all iodine species to iodide which can then be measured using an iodide electrode (ISE).

As the pyrohydrolysis technique results in oxidation of the matrix material, it can also be applied to carbon containing species, CO₂ being the evolved product. CO₂ is also, conveniently, trapped in aqueous NaOH. Hence pyrohydrolysis offers the possibility of determining both ¹⁴C and ¹²⁹I from a single sample aliquot. However, a problem when applying the pyrohydrolysis technique to carbon containing matrices is that the trap solution be contaminated with atmospheric levels of ¹⁴CO₂ which would lead to an error in the measured ratio of ¹⁴C:¹²C. Very careful handling of the trap solutions is therefore required. The amount of carbon, as CO₃²⁻, in the trap solution can be determined by treatment with barium chloride solution to precipitate barium carbonate and determination of the unreacted NaOH by titration with standard acid to the phenolpthalein end point.

Carriers

Working with exceedingly small amounts of radioactive materials (iodine and carbon in this case) is facilitated by diluting the radionuclide with isotopic or at least chemically similar material. The added material is referred to as a carrier. Ordinary inactive sodium, for example, may be added to radiosodium, so that there is perhaps 10⁻² g of material to handle rather than say 10⁻¹⁵ g. For many purposes the presence of the sodium carrier is unobjectionable because, being isotopic, its chemistry is virtually identical with that of the radiosodium.

Due to the highly complex nature of the HAL liquors, almost every element of the periodic table is likely to be present in some quantity and the choice of carrier(s) is quite a difficult one. Ideally, the carrier of choice should contain both iodine and carbon. The nature of the HAL liquors (˜10M HNO₃) also needs to be taken into account as many substances may be volatilised under these conditions. With iodine, the matter is simplified as only ¹²⁷I occurs naturally and therefore the contribution to the ¹²⁹I content of the sample is affected. With carbon, however, the matter is slightly more complex due to the presence of naturally occurring ¹⁴C in the atmosphere (it is produced in the upper atmosphere by the action of cosmic rays on ¹⁴N). The carrier for carbon should therefore originate from ‘dead carbon’. This is carbon in which all the radioactive ¹⁴C has diminished to zero concentration due to its age, such as that in fossil fuels. Examples are compounds originating from petrochemicals or coal. The carrier should also be water soluble so that it can be manipulated in a hot cell by pipetting into the sample containing crucible and most importantly the carrier should pyrohydrolyse in the same temperature range as the sample of interest. For example, if the carrier pyrohydrolysed at 200° C. but the other species in the HAL sample pyrohydrolysed at much higher temperatures then it would not be an effective carrier and the radioactive sample may be lost on the walls of the furnace tube.

Carriers Include:

Inorganic Carbon: CaCO₃, graphite, WC
Organic Carbon: ⁿBu₄I (TBA), naphthalene, 1-Iodooctane
Inorganic Iodine: AgI, CsI, KI, CuI, KI₃, KIO₃
Organic Iodine: TBAI, 1-Iodooctane

A particularly suitable carrier is a quatenary alkyl ammonium iodide for instance, tetra-butyl ammonium iodide (TBAI). It is a source of both carbon and iodine and is water soluble.

The pyrohydrolysis results for the above-mentioned carriers are shown in Table 1.

TABLE 1

| Compound | Yield |
|---|---|
| CaCO₃ | 98% |
| Graphite | 97% |
| WC | 98% |
| AgI | 100% |
| CsI | 100% |
| GuI | 100% |
| KI | 98% |
| KIO₃ | 99% |
| KI₃ | 97% |
| TBAI | C - 101%, I - 98% |
| Naphthalene | 97% |
| 1-Iodooctane | C - 99%, I - 99% |

In carrying out pyrohydrolysis with these materials, various factors may need to be controlled in order to give best results, including catalyst temperature, amount of oxygen and temperature ramp rate.

The yields quoted in Table 1 are the average values for five or more reactions. The pyrohydrolysis of CaCO₃, graphite and WC in the early reactions was performed with approximately 50 g of 0.5% Pt on” alumina.

The pyrohydrolysis of AgI and CsI benefits from the addition of V₂O₅ accelerator. In the absence of V₂O₅, the result is distillation of these compounds. In the case of CsI, some decomposition to release iodine does take place at high temperature, but with AgI there is no decomposition observed. CuI can be pyrohydrolysed without the addition of V₂O₅ and decomposes readily at ˜200-300° C. KI has been investigated and was found to behave in a similar manner to CsI, i.e. some decomposition is observed at higher temperatures but V₂O₅ is required for a quantitative recovery of iodine. Pyrohydrolysis of KI₃ solution leads to evaporation of iodine at ˜100-130° C., leaving a white residue of KI. Again, V₂O₅ is required for complete recovery of iodine. A low iodine recovery for pyrohydrolysis of KIO₃ was encountered in the absence of V₂O₅. After heating the sample to 1000° C. and cooling, a white residue of KI remained in the combustion boat. Repeating this reaction with V₂O₅ added resulted in quantitative recovery of iodine.

All the reactions described above were performed with moist air as the carrier gas at a flow rate of 100 ml/min.

V₂O₅ has minimal effect in the pyrohydrolysis of TBAI as TBAI evaporates from the boat at low temperature (130° C.).

In order to establish the decontamination factors for volatile species containing Cs, Sr and Ru, experiments were conducted involving the pyrohydrolysis of a mixture of CsNO₃, Sr(NO₃)₂ and [Ru(NO)(NO₃)₂(OH)] in dilute nitric acid. The nitric acid was removed by heating to 90° C. for 30 minutes. The mixture was then heated to 1000° C. in a stream of moist air at 100 ml/min and 50 g of the Pt catalyst. The resulting trap solution remained colourless at the end of the experiment, indicating little Ru carry over. The amounts of Cs, Sr and Ru in the trap were established by ICP-MS. The decontamination factor (DF) required in order to remove the trap solution from a hot cell into a fume hood is ˜2500.

The pyrohydrolysis of the compounds discussed above has demonstrated that their carbon and iodine content can be quantitatively released and trapped in aqueous solution.

Method

The fundamental conditions required for the pyrohydrolysis of any material introduce a number of variable parameters into the experimental design.

The basic parameters are:
Steam
Gas flow
Identity of gas
Temperature
Trapping media

Depending upon the type of material under investigation, a number of extra parameters may be required such as:
Gas flow rate
Rate of temperature increase
Oxidation accelerators
Trapping efficiency—concentration of solution, gas-liquid contact etc
Conversion catalysts—nature, quantity required, temperature of operation etc

The requirement for carbon, as well as iodine, quantitation has meant that instead of the usual single furnace setup, a second furnace is also necessary. The second furnace oxidises any material (such as CO) released from the first furnace at low temperature. As such, the second furnace is operated at a higher temperature (say 300-1000° C.). An experimental setup is illustrated in FIG. 2.

This consists of a carrier gas cylinder (A), flowmeter (B), sodium hydroxide trap (C), steam generator (D), two tube furnaces (E&G), heater tape (F), condenser tube (H) and trap vessel (J). The carrier gas, either N₂, O₂ or air, is passed through a trap solution of saturated NaOH to remove any carbon dioxide. This is bubbled through a 500 ml three neck flask containing anti-bumping granules and de-ionised water at 90-100° C. The steam generated is fed through a 28 mm two piece quartz furnace tube containing the sample in a quartz boat (˜80 mm×21 mmØ). The sample furnace is of the hinged type so that the reaction progress can be monitored. The temperature can be programmed through an eight segment controller to ramp up to a maximum temperature of 1200° C. A second tube furnace of the fixed type has a set temperature so that any volatile species released from the sample in the first furnace at low temperature are pyrolysed fully before being trapped. Each furnace is ˜500 mm in length and the two tubes are joined by a ball and socket joint, which is heated by an electrical tape heater to minimise condensation between the two furnaces. A fritted tube is fitted to the end of the condenser in order to maximise contact between the evolved gases and the NaOH trap solution. The receiver vessel is a 250 ml polypropylene bottle which is open to the atmosphere.

The steam generator required for pyrohydrolysis consists of a 500 ml round bottom flask containing anti-bumping granules. This is equipped with a quickfit gas supply inlet, thermometer and outlet to the furnace tube. The temperature is controlled by an electric heater mantle. The temperature of the steam is regulated at 90-100° C. Condensation in the opening to the furnace tube is prevented by heating this area with a resistive heater tape (not shown in figure).

In the case of metal iodides and iodates steam is required to break open the matrix. However, for carbon containing compounds the presence of steam is not required. Inclusion of steam in these reactions leads to a higher temperature requirement before complete oxidation is achieved. Thus, graphite is oxidised in a stream of dry oxygen at ˜500-550° C., whereas in a stream of moist oxygen oxidation does not commence until ˜700° C. The presence of steam was found to have no detrimental effect on the efficiency of the Pt catalyst and, in fact, is probably desirable for the oxidation of CO to CO₂.

The design of the trap solution vessel has to be taken into account as the final volume can almost double depending on the time-scale of the experiment. Initially, the trap vessel consisted of a 250 ml plastic bottle but this was replaced by a 125 ml quickfit Dreschel bottle.

The purpose of the carrier gas is to promote steam generation and to carry any sample evolved gases into the trap solution. A high enough flow rate is required so that any evolved gases cannot diffuse back towards the steam generator and therefore be lost. However, too high a flow rate can lead to a lower trapping efficiency of CO₂. For example, the yield of CO₂ from the combustion of graphite in O₂ gradually diminished as the flow rate was increased. The ideal flow rate is approximately 100 ml/min.

The identity of the carrier gas is not important in the pyrohydrolysis of iodine containing compounds as it is the steam that causes reaction and not the carrier gas. Hence, quantitative yields of iodine can be achieved with N₂, O₂ or air as the carrier gas. However, as the conversion of carbon to CO₂ is essentially a combustion reaction, the carrier gas must contain oxygen. As the use of pure O₂ in the pyrohydrolysis of TBAI led to violent reactions with partially oxidised organic material being deposited over the wholelength of the furnace tube, and its use inside a hot cell may pose a high risk in the event of a failure, the experimental conditions have been developed so that air can be used instead. All the results in Table 1 were achieved with moist air as the carrier gas.

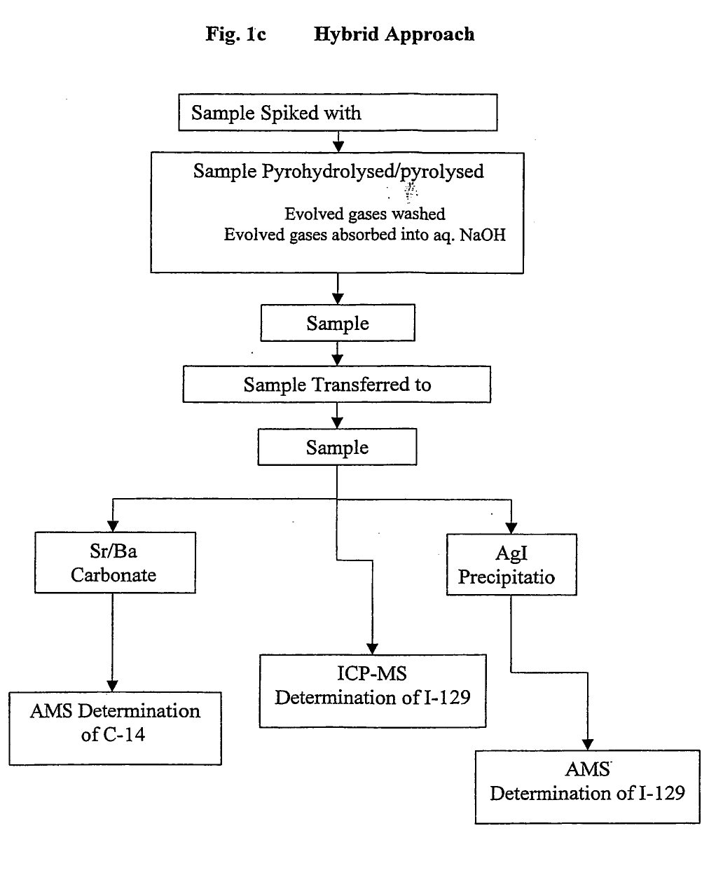

A possible drawback with the apparatus shown in FIG. 2 was that the area between the two furnaces could act as a cold spot. Whereas this did not affect the CO₂ recoveries from inorganic compounds such as graphite, WC and CaCO₃, carbon derived from organic compounds such as TBAI would be lost as it condensed on the cold spot. With graphite, WC and CaCO₃ the high melting points mean that the sample only migrates from the quartz boat as it is oxidised. With organic compounds, such as TBAI, the low melting points lead to evaporation and eventual decomposition on the walls of the furnace tube around the cold spot. As this area could not be heated high enough to oxidise the coating, carbon was lost and this could give rise to low CO₂ recoveries. A modified apparatus is shown in FIG. 3. The furnace tube mountings were fabricated so that the two furnaces could be moved closer together (˜2 mm gap). The furnace tube was also changed from the two piece to a single piece variety. The decomposition of TBAI still led to a black deposit in the region between the two furnaces but this could now be oxidised as the temperature of the sample containing furnace was ramped up, hence the higher CO₂ recoveries.

Oxidation Accelerators

The pyrohydrolysis of inorganic halides such as CsI, KI and AgI benefit from the addition of an oxidation accelerator such as V₂O₅. Without an accelerator, pyrohydrolysis can result in only partial decomposition and release of iodine in the case of CsI and KI, and no decomposition for AgI. By contrast, CuI was found to readily decompose at low temperature and V₂O₅was not required.

Other oxidation accelerators include U₃O₈ and WO₃.

Trapping Solutions

As CO₂, I₂ and HI can all be quantitatively and simultaneously trapped in aqueous NaOH, this was the ideal choice for the trapping solution. Initial investigations on the combustion of graphite with molar equivalents of NaOH in the trap, i.e. 10 mmol CO₂≡20 mmol NaOH (CO₂+2NaOH→Na₂CO₃+H₂O), revealed that CO₂ was being lost from the trap. This was determined by fitting a second trap and examining it for CO₂ content. A series of graphite combustion experiments were conducted with 100 ml/min O₂ flow and increasing molar equivalents of NaOH in the first trap. These experiments revealed that a two times molar equivalent of NaOH was preferred for 100% CO₂trapping efficiency, ie. 10 mmol CO₂ requires 40 mmol NaOH. The concentration of the NaOH was not found to be important, hence the solutions could be diluted to gain adequate volume. A large excess of NaOH in the trap is undesirable as this could lead to absorption of atmospheric ¹⁴CO₂ in the hot cell work.

The trap solutions from the pyrohydrolysis of compounds containing only carbon (graphite, WC, CaCO₃, naphthalene) were diluted to 250 ml and 50 ml aliquots were treated with a slight excess of 0.1M BaCl₂ solution to precipitate the absorbed CO₂ as BaCO₃. The unreacted NaOH could then be determined by titration with standard acid to the phenolpthalein endpoint. The recovery of CO₂ could then be calculated from the amount of reacted NaOH.

Trap solutions from the pyrohydrolysis of compounds containing only iodine (AgI, CsI, CuI, KI, KI₃, KIO₃) were neutralised with 1M HCl and treated with ascorbic acid to reduce all iodine species to iodide. The iodide concentrations were then determined with an iodide specific electrode.

Trap solutions from the pyrohydrolysis of compounds containing carbon and iodine (TBAI, 1-iodooctane) were diluted to 250 ml. 50 ml was taken and treated as described above for iodine analysis. Of the remaining solution, 50 ml aliquots were titrated against standard acid and the CO₂ recovery then corrected by subtraction of the iodine content. A first trap contained KI solution to trap iodine and a second trap contained NaOH to trap the CO₂. Iodine and CO₂ recoveries were then calculated from titrations with thiosulphate and standard acid respectively.

Conversion Catalyst

It is preferred that a catalyst such as platinum (Pt) be used to convert any CO formed to CO₂. Pt also promotes the decomposition of hydrocarbons which is desirable for the reactions with TBAI, naphthalene and 1-iodooctane.

A suitable form of catalyst was 0.5% Pt coated on ⅛″ (3.18 mm) alumina pellets. These were packed into the second, high temperature, furnace and provided very good contact with the gas throughput.

The temperature of the Pt catalyst could be maintained anywhere between 300° and 1000° C. without effecting its efficiency to oxidise CO to CO₂. It was discovered that the low CO₂ recoveries from the pyrohydrolysis of graphite, CaCO₃ and WC were attributable to the amount of Pt catalyst being employed. This had to be increased from ˜20 g (packing length of ˜2″ (50.8 mm)) to ˜50 g (˜5″ (127 mm) length) in order to achieve quantitative recoveries of CO₂. Iodine was not found to effect the efficiency of the Pt catalyst.

General Pyrohydrolysis Procedure

A general procedure for pyrohydrolysis is as follows:

40-1000 mg of the compound under investigation and a 2-3 times excess of V₂O₅ were weighed into a quartz boat and placed in the furnace tube at room temperaturewhich was then heated. Moist air was passed through the apparatus at a flow rate of 100 ml/min. The evolved gases were passed through a Pt catalyst which was typically maintained at 900° C.

Preferred Method Features

The method development identified the following conditions as preferred for the pyrohydrolysis of iodine/carbon containing compounds or mixtures of these compounds;
Steam supply @ 90-100° C.
O₂ or air @ 100 ml/min flow rate (air is preferred for organics)
Temperature profile (especially for organics)
In most cases V₂O₅ accelerator is preferred for pyrohydrolysis of metal iodides/iodates
Correct quantity of Pt catalyst
Two molar equivalents of NaOH for quantitative trapping of CO₂ @ 100 ml/min flow rate
No cold spots in apparatus
   Options for Hot Cell Operation

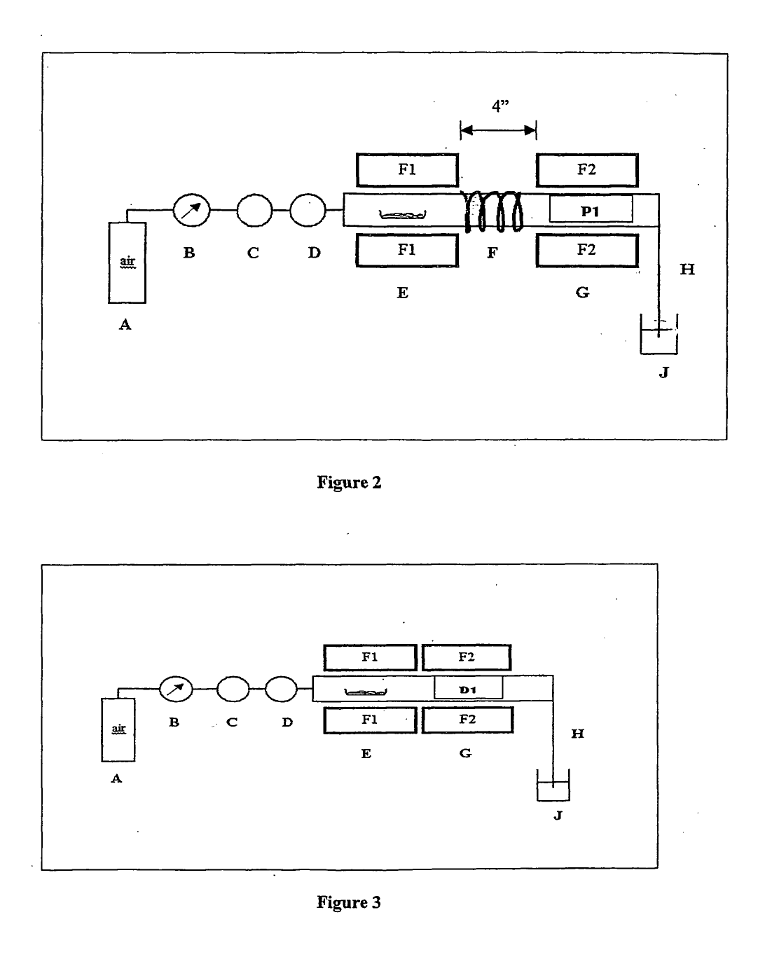

A number of modifications are preferred in order to operate the pyrohydrolysis apparatus inside a hot cell. For instance, the current apparatus is too large to fit inside the hot cell transport bogey. Any apparatus being transported in or out of the hot cell has to fit inside a 255 mmØ×355 mm a metal container. This means that the maximum practical furnace tube length will be approximately 430 mm. This is roughly half the current length. The furnace set up either consists of two 150 mm long furnaces or a single two zone furnace of 350 mm in length. The furnace controllers will be situated outside the hot cell so special mountings will need to be fabricated for the furnace barrels. All the furnace tube joints will probably be ball and sockets, held in place with metal clips. The design of the apparatus should be as simple as possible in order to ease and reduce the number of master/slave manipulations. An experimental set up is illustrated in FIG. 4. The heated spoon configuration suggested here allows simplified sample loading and reduces manipulations to a basic sliding operation. The resistive heating allows the nitric acid solvent to be evaporated before the sample is slid into position within the furnace.

The sample consists of ˜1 ml of dissolver liquor, which is ˜10M in HNO₃. This can loaded into the heated spoon by pipetting through the opening shown in FIG. 4. As V₂O₅ accelerator is preferred for the pyrohydrolysis of metal iodides and iodates. As V₂O₅ is a free flowing solid, this may be added by tipping a pre-weighed excess from a small vial. A calibrated amount of TBAI carrier (˜50 mg) in aqueous solution could then be added, again by pipette. Loading the spoon in this order minimises volatilisation of iodine from the TBAI carrier as the nitric acid would be neutralised by the V₂O₅. Another approach would be to heat the spoon to evaporate the nitric acid before adding the V₂O₅ and carrier.

The temperature profile for the hot cell experiments may resemble that displayed in FIG. 5. An initial dwell period at approximately 90° C. is preferred in order to evaporate the solvent. After evaporation to dryness, the spoon is moved into the furnace and a slow temperature ramp started (˜5° C./min up to 1000° C.). The heating cycle lasts for approximately 4 hours.

Once the trap solution containing the ¹⁴C and ¹²⁹I has been suitably decontaminated, it will be split and treated with BaCl₂ and AgNO₃ solutions to precipitate BaCO₃ and AgI respectively. Further decontamination may then be required so that these samples can be shipped off site for AMS (accelerator mass spectrometry) measurement of the ¹⁴C:¹²C and ¹²⁹I:¹²⁷I ratios. The BaCO₃ can be purified by treatment with acid and re-absorption of the released CO₂ into NaOH. Another approach is to cryogenically trap the CO₂ and then reduce it to carbon by reaction with H₂ over a heated Fe catalyst.

1-35. (Canceled)

36. A method for the determination of specified radionuclides, comprising the steps of:
adding a combined carrier and a tracer to a sample to be analysed;
mineralizing the sample comprising pyrolysizing and/or pyrohydrolysizing the sample;
isolating a resulting analyte; and
analyzing the analyte.

37. A method according to claim 36, wherein mineralizing the sample comprises pyrohydrolysizing the sample.

38. A method according to claim 37, wherein pyrohydrolysizing the sample comprises converting all chemical and physical forms of the analyte into soluble, inorganic forms.

39. A method according to claim 37, wherein analyzing the analyte is based upon pyrohydrolysis of both C-14 and I-129 in a single sample aliquot.

40. A method according to claim 37, wherein mineralizing the sample comprises remotely pyrohydrolysizing the sample in a shielded facility.

41. A method according to claim 40, further comprising processing the sample in the shielded facility to allow export to the radio-bench.

42. A method according to claim 40, further comprising purifying the sample and preparing a source at the radio-bench.

43. A method according to claim 42, further comprising diluting the sample in a shielded facility to determine I-129 and/or C-14.

44. A method according to claim 43, wherein diluting the sample comprises calibrating using isotope dilution methodologies.

45. A method according to claim 43, wherein pyrohydrolysizing the sample, purifying the sample, preparing the source are performed in a low-level protection environment.

46. A method according to claim 36, further comprising:
absorbing and/or adsorbing evolved gases onto and/or into a substrate after mineralizing the sample.

47. A method according to claim 36, wherein isolating the resulting analyte comprises purifying the analyte.

48. A method according to claim 36, wherein analyzing the analyte comprises determining analytes of interest by classical radiometric techniques and/or by inorganic mass spectrometry

49. A method according to claim 48, wherein analyzing the analyte comprises determining analytes of interest by inorganic mass spectrometry.

50. A method according to claim 49, wherein the inorganic mass spectrometry is inductively coupled plasma mass spectrometry.

51. A method according to claim 50, wherein the analyte is I-129 or Tc-99.

52. A method according to claim 49, wherein the inorganic mass spectrometry is accelerator mass spectrometry.

53. A method according to claim 52, wherein the analyte is I-129, C-14, Tc-99 or Cl-36.

54. A method according to claim 48, wherein analyzing the analyte comprises determining analytes of interest by classical radiometric techniques.

55. A method according to claim 54, wherein the analyte is I-129, C-14, Tc-99, S-35, Ru-106 or Cl-36.

56. A method according to claim 36, wherein the analyte comprises at least one of C-14, I-129, Cl-36, Tc-99, S-35 and Ru-106.

57. A method according to claim 36, wherein the sample comprises process streams or materials, process wastes, and/or waste forms of interest in the nuclear fuel cycle.

58. A method according to claim 57, wherein the sample may be in a range from highly radioactive to non-radioactive.

59. A method according to claim 36, wherein the sample is of environmental concern and interest.

60. A method according to claim 36, wherein mineralizing the sample comprises:
pyrohydrolysizing the sample in a first zone in a furnace; and
oxidizing the sample in a second zone in the furnace.

61. A method according to claim 60, wherein the first zone is maintained at a substantially constant temperature and the second zone is temperature programmed.

62. A method according to claim 36, wherein the sample comprises iodine, and mineralization of the sample comprises using a catalyst to aid conversion of iodine to hydrogen iodide.

63. A method according to claim 62, wherein the catalyst is a metal oxide.

64. A method according to claim 63, wherein the catalyst is vanadium pentoxide.

65. A method according to claim 36, wherein mineralization of the sample comprises using an oxidation catalyst to aid conversion of any carbon monoxide and/or volatile organic compounds to carbon dioxide.

66. A method according to claim 65, wherein the oxidation catalyst is platinum or alumina.

67. A method according to claim 36, wherein the carrier is a quaternary alkyl ammonium iodide.

68. A method according to claim 67, wherein the carrier is tetra-butyl ammonium iodide.
